(19) United States
(12) Patent Application Publication
(10) Pub. No.: US 2014/0253988 A1
(43) Pub. Date: Sep. 11, 2014

(54) HOLOGRAM GENERATING APPARATUS

(71) Applicant: Zebra Imaging, Inc., Austin, TX (US)

(72) Inventor: Craig D. Newswanger, Austin, TX (US)

(21) Appl. No.: 13/912,419

(22) Filed: Jun. 7, 2013

Related U.S. Application Data
(60) Provisional application No. 61/773,297, filed on Mar. 6, 2013.

(51) Int. Cl. G03H 1/04

(52) U.S. Cl. CPC G03H 1/041
USPC 359/10

(57) ABSTRACT

A hologram generating apparatus and method. In one embodiment of the apparatus includes a base and a rigid platform. The rigid platform is movably coupled to the base. Several components are fixedly attached to the rigid platform and are movable relative to the base. For example, a source for emitting an electromagnetic beam, a beam splitter for splitting the electromagnetic beam into an object beam and a reference beam, a reference beam component for receiving the reference beam, and an object beam component for receiving the object beam are each fixedly mounted to the rigid platform.

### CROSS-REFERENCE TO RELATED APPLICATIONS

This application claims the domestic benefit under Title 35 of the United States Code §119(e) of U.S. Provisional Patent Application Ser. No. 61/773,297, entitled “Hologram Generating Apparatus,” filed Mar. 6, 2013, which is hereby incorporated by reference in its entirety and for all purposes as if completely and fully set forth herein.

### BACKGROUND OF THE INVENTION

1. Field of the Invention

The present invention relates to the field of holographic stereograms (holograms) and, more particularly, to an apparatus and method for generating holograms.

2. Description of the Related Art

Holography typically refers to techniques for making three-dimensional (3D) images, e.g., holograms. A hologram can be composed of a number of small, elemental pieces known as hogels. In contrast to 2D pixels, hogels contain 3D information from various perspectives. However, due to various limitations in hologram generation methods and techniques, holograms can be expensive, difficult, and/or time consuming to produce. The equipment used to create holograms can be expensive, and can be unreliable due to machine complexity, constraints of optical paths, and mechanical tolerances.

### SUMMARY OF THE INVENTION

A hologram generating apparatus and method. In one embodiment of the apparatus includes a base and a rigid platform. The rigid platform is movably coupled to the base. Several components are fixedly attached to the rigid platform and are movable relative to the base. For example, a source for emitting an electromagnetic beam, a beam splitter for splitting the electromagnetic beam into an object beam and a reference beam, a reference beam component for receiving the reference beam, and an object beam component for receiving the object beam are fixedly mounted to the rigid platform.

### BRIEF DESCRIPTION OF THE DRAWINGS

The embodiments of the present application may be better understood, and its numerous objects, features, and advantages made apparent to those skilled in the art by referencing the accompanying drawings.

FIG. 1 is a diagram illustrating a hologram generating device, according to an embodiment.

FIGS. 2A and 2B are diagrams illustrating alternate views of a hologram generating device, according to an embodiment.

FIG. 3 is a diagram illustrating a view of a hologram generating device, according to an embodiment.

FIG. 4 is a diagram illustrating an additional view of a hologram generating device, according to an embodiment.

FIG. 5 is a block diagram illustrating a portion of an object beam module of a hologram generating device, according to an embodiment.

FIG. 6 is a block diagram illustrating a portion of a recording material system of a hologram generating device, according to an embodiment.

FIG. 7 is a flowchart of a method illustrating operation of a hologram generating device, according to one embodiment.

FIG. 8 is a block diagram of various modules

While the embodiments of the application are susceptible to various modifications and alternative forms, specific embodiments are provided as examples in the drawings and detailed description. It should be understood that the drawings and detailed description are not intended to limit the embodiments to the particular form disclosed. Instead, the intention is to cover all modifications, equivalents and alternatives falling within the spirit and scope of the invention as defined by the appended claims.

### DETAILED DESCRIPTION

A hologram generating device is disclosed. The device is configured to generate or record holograms, which may take form in digital holograms, including horizontal-parallax-only (HPO) and full parallax holograms.

The hologram generating device may include a base, a translation module, a hologram recorder, and a recording material system. The base of the hologram generating device is stationary. The recording material system can be fixedly attached to the base and configured to house a holographic recording material in which holograms can be recorded. In one embodiment, the holographic recording material may take form in a flexible film that can be transferred between supply and take-up reels within the recording material system. In this configuration, the holographic recording material is movable within the recording material system.

The translation module may include at least two components; a stationary translation module and a movable translation module. The moveable translation module can be fixedly attached to the hologram recorder, while the stationary translation module can be fixedly attached to the base. The movable translation module, as its name implies, can move relative to the stationary translation module, and as a result, the hologram recorder is movable relative to the stationary translation module. During hologram recording, the movable translation module can move along a first line, while the holographic recording material can move along a second, orthogonal or substantially (i.e., within tolerance) orthogonal line. As used herein, the definition of orthogonal lines is meant to include a pair of skew lines with multiplied gradients equal or substantially equal to negative one. Thus the first line and the second line may be non-coplanar orthogonal lines or lines. The hologram recorder can create a row of hogels in the holographic recording material as the hologram recorder moves in the first direction. Although the remaining disclosure will be described with reference to the translation module and the holographic recording material moving along orthogonal first and second lines, respectively, the present invention should not be limited thereto. In an alternative embodiment, hogels can be created as the hologram recorder moves along a first line that is curved, for example, to match a curvature of a holographic recording material.

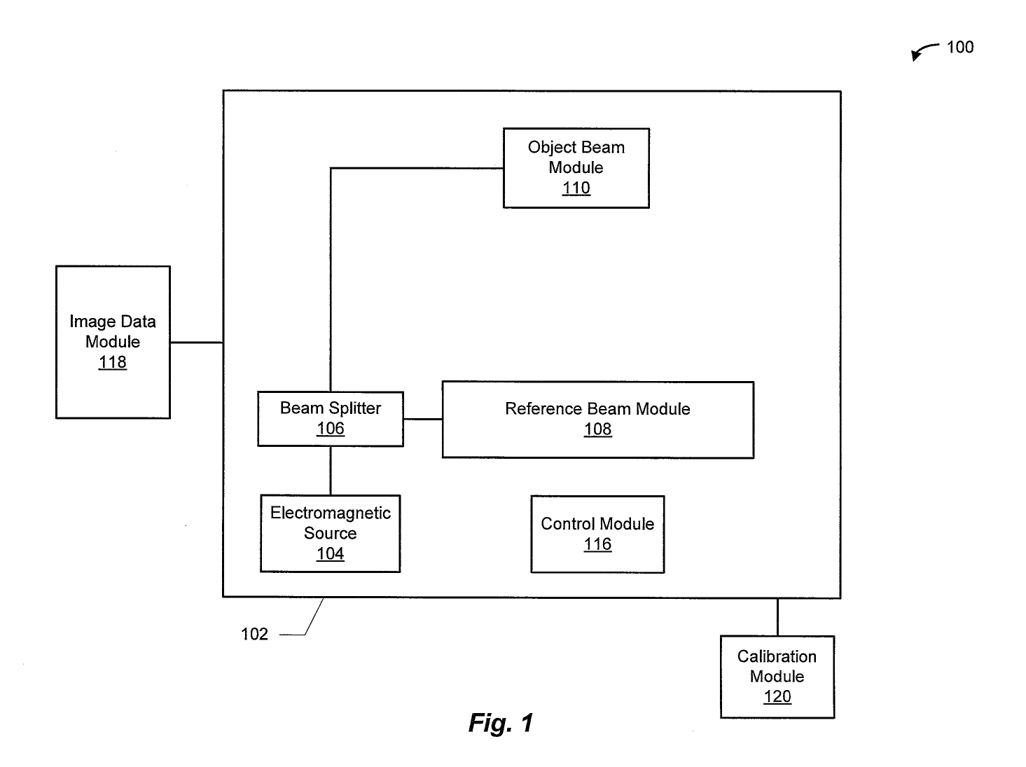

FIG. 1 conceptually shows select components that may be contained in an example hologram recorder 100. A housing 102 (conceptually shown) of the hologram recorder 100 is fixedly connected to the movable translation module (not shown). Housing 102 houses several components including an electromagnetic beam source 104, a beam splitter 106, a reference beam module 108, an object beam module 110, and a control module 116. Importantly, optical components within housing 102 are structurally integrated with each other so that they collectively move in parallel as the movable translation module, and thus housing 102, moves along the first line during hologram generation. The collective and parallel movement of the optical components can preserve alignment between optical components within housing 100, an important requirement for proper hologram generation. Components within housing 102 may communicate with an image data module 118 and a calibration module 120. In one embodiment, image data module 118 and calibration module 120 may be contained within housing 102.

Electromagnetic source 104 may take form in one or more lasers, infrared light sources, or ultraviolet light sources, etc. Electromagnetic source 104 emits an electromagnetic beam (e.g., laser). This beam may include components of distinct wavelengths or distinct bands of wavelengths. Beam splitter 106 splits the electromagnetic beam into object and reference beams. An example beam splitter is described in U.S. Pat. No. 6,330,088 (the '088 patent), which is incorporated herein by reference in its entirety.

Object beam module 110 receives the object beam from splitter 106 and image data from image data module 118. The image data may correspond to views of a 3D image. Object beam module 110 can modulate the object beam using the image data to create a modulated object beam. Object beam module 110 can also redirect the modulated object beam to a surface of a holographic recording material (not shown in FIG. 1).

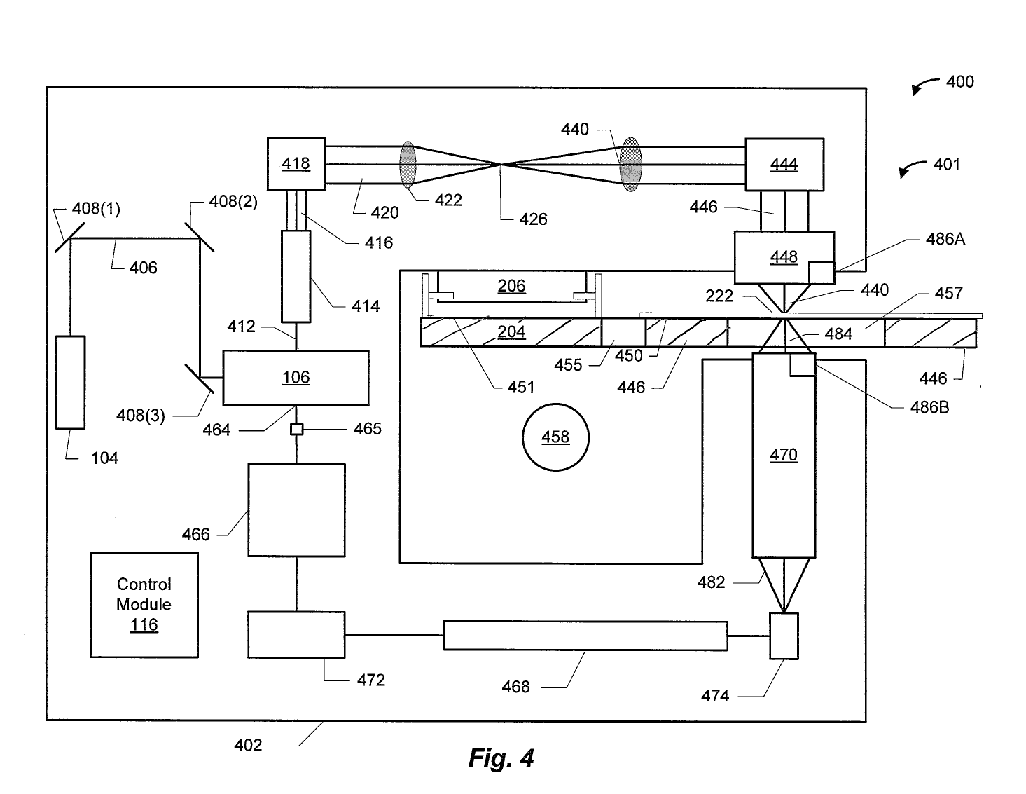

Reference module 108 can receive and redirect the reference beam to the holographic recording material where the reference beam can interfere with the modulated object beam and create hogels. U.S. Pat. No. 7,190,496 (the '496 patent), which is incorporated herein by reference in its entirety, gives an example description of hogel creation using interference between a reference beam and modulated object beam. In one embodiment, reference beam module 108 is implemented using 4F relays. Example 4F relays are described below with reference to FIG. 4.

The length of a reference path (i.e., distance travelled by the reference beam) should be substantially similar to the length of an object path (i.e., the distance travelled by the object beam and/or the modulated object beam). Path length matching optics (not shown in FIG. 1) fixedly mounted within housing 102 can adjust the length of the reference path to match the length of the object path, or to bring the two path lengths within a distance of each other that is less than or equal to a coherence length of the electromagnetic source.

Control module 116 or calibration module 120 can include one or more processors and a memory that stores instructions executable by the one or more processors. In some embodiments, control module 116 or calibration module 120 can be implemented using one or more central processing units (CPUs), programmable microcontrollers (MCUs), complex programmable logic devices (CPLDs), field-programmable gate arrays (FPGAs), application-specific integrated circuits (ASICs), and/or digital signal processors (DSPs), among others. Control module 116 can control features of object beam module 110 and reference beam module 108 as more fully described below. Calibration module 120 can be used to calibrate certain components within housing 102 before each hologram recording session. For example, some optical elements can be calibrated by calibration module 120 to maintain focus of a Fourier transform lens at a certain distance from the surface of the holographic recording material.

Optical components such as electromagnetic beam source 104, beam splitter 106, etc., should be properly aligned to insure the modulated object beam interferes with the reference beam in the hologram recording material to create hogels with little or no flaws. If the optical components fall out of alignment during hologram generation, the process may produce flawed holograms. Because optical components within housing 102 are structurally integrated with each other, the components once aligned for optimal hologram generation, should remain in proper alignment.

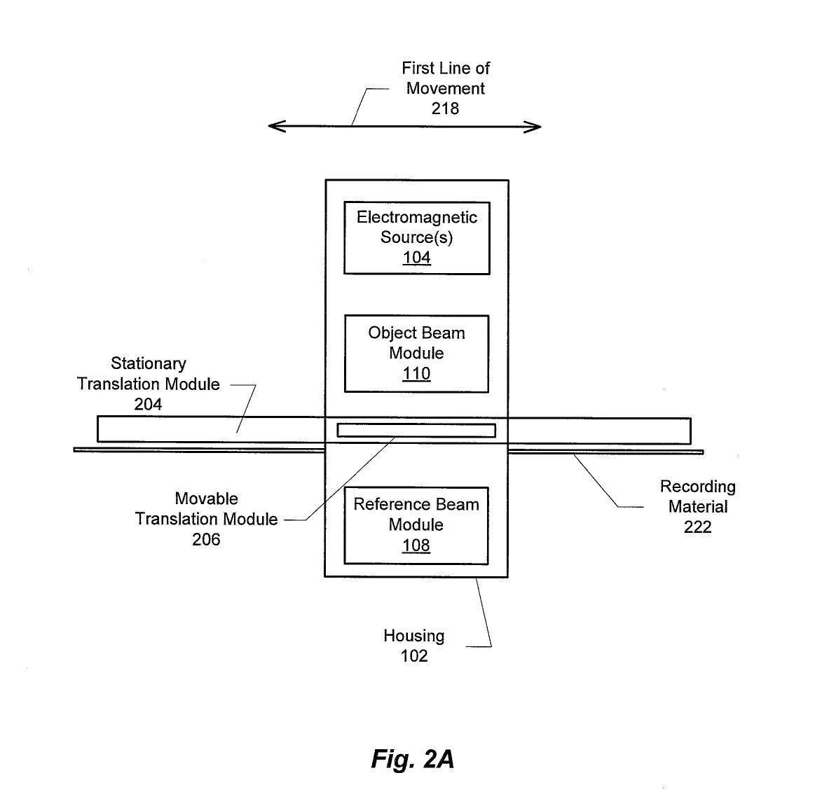

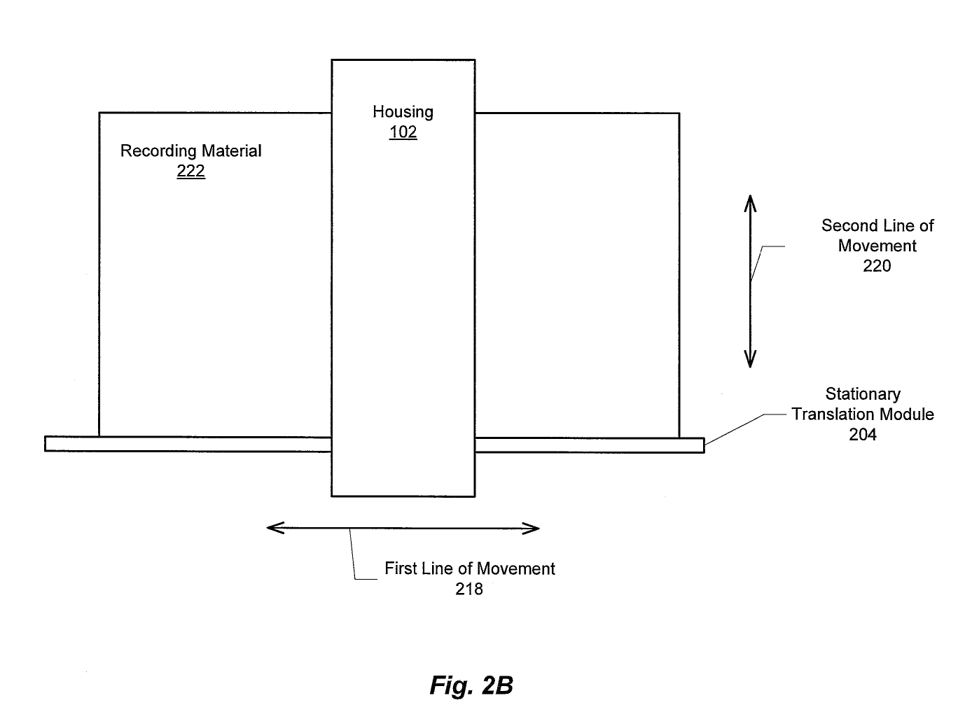

With continuing reference to FIG. 1, FIGS. 2A and 2B are conceptual views of the hologram recorder and the holographic recording material as seen from the front and top, respectively. The holographic recorder in FIG. 2A includes housing 102, which in turn contains beam source 104, reference beam module 108, and object beam module 110. Housing 102 is fixedly attached to movable translation module 206, which in turn is movably coupled to stationary translation module 204. FIGS. 2A and 2B illustrate movement of the hologram recorder and the holographic recording material in orthogonal directions. Any one of various types mechanisms can be employed to advance the combination of housing 102 and movable translation module 206 over stationary translation module 204 along a first line parallel to line 218.

Holographic recording material 222, which is shown in cross section, is illuminated on opposing surfaces by the modulated object beam and reference beam from object beam module 110 and reference beam module 108, respectively. Interference between these beams creates hogels within holographic recording material 222. After a line of hogels is created, movement of housing 102 can be paused while the holographic recording material 222 is advanced along the orthogonal, second line. Any one of various types of mechanisms can be used to advance recording material 222 along the second line. Once the holographic recording material 222 is advanced, housing 102 translates along the first line and a new line of hogels is created. FIG. 2B illustrates a top view of components shown in FIG. 2A. FIG. 2B shows lines 218 and 220, which are parallel to the first and second lines of translation, respectively, for housing 102 and holographic recording material 222, respectively. Because optical components (e.g., beam source 104, reference beam module 108, object beam module 110, etc.) needed to create hogels are structurally integrated within housing 102, alignment of these components with each other and with holographic recording material 222 should be maintained as housing 102 moves along the first line and as holographic recording material 222 moves along the second line.

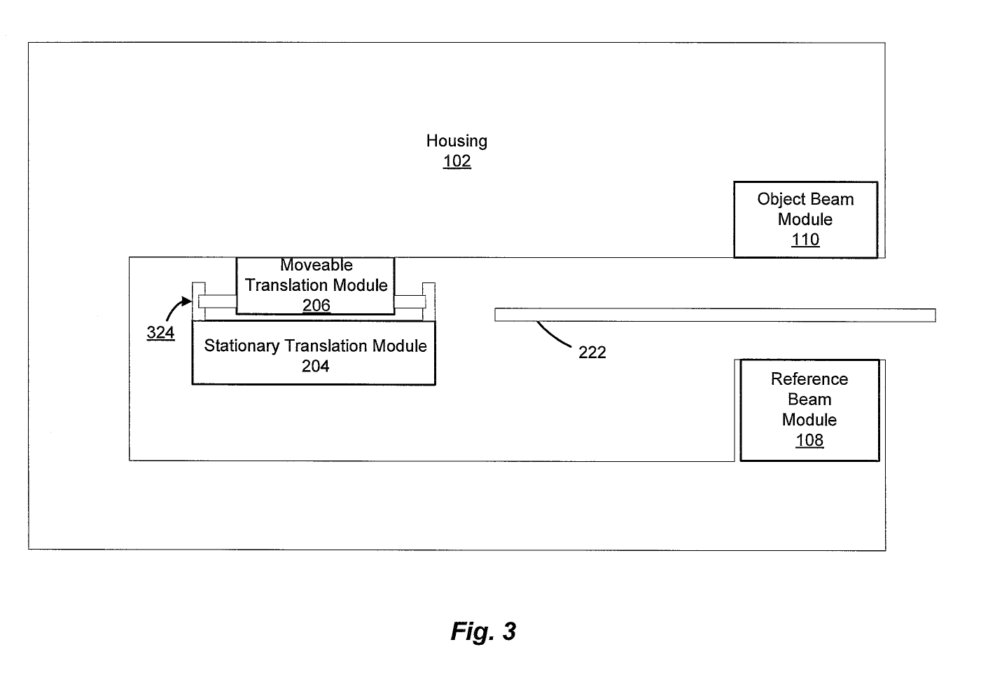

FIG. 3 is a conceptual, cross sectional side view of components shown in FIGS. 2A and 2B. Housing 102 may have a C-shaped configuration that includes an opening through which recording material 222 can extend and be illuminated on opposite surfaces by the modulated object beam and the reference beam. Additional details of an example embodiment of stationary translation module portion 204 and movable translation module portion 206 are shown in this view. In particular, movable translation module 206, which is fixedly attached to housing 102, may include wheels 324 that can roll along a flat surface of stationary translation module 204. A controlled motor (e.g., a stepper motor or servo motor, not shown) can provide the means for moving translation module 206, and thus housing 102, relative to both stationary translation module 204 and holographic recording material 222. FIG. 3 also shows object beam module 110 and reference beam module 108 are mounted in housing 102 on opposing sides of holographic recording material 222. This configuration enables the oppositely facing surfaces of holographic recording material 222 to be illuminated by the modulated object beam and reference beam, respectively, as housing 102 translates along the first line. A sensor can detect the location of the movable translation module 206 on the stationary translation module 204, and generate a corresponding signal that can be used by control module 116.

With continuing reference to FIGS. 1, 2A, 2B, and 3, FIG. 4 includes a conceptual side view of several components inside housing 102. In one embodiment, components such as electromagnetic beam source 104, beam splitter 106, mirrors or other reflective elements, etc., many of which are shown in block diagram form, are fixedly mounted on a C-shaped, rigid platform, board, or substrate (hereinafter platform) 402. The term rigid platform can refer to a solid, non-bendable structure that is formed as a single component or formed by fastening (e.g., welding) several components together. The term rigid platform can also refer to a structurally reinforced structure or a structure designed to resist deformation. Rigid platform 402 can be sized to fit inside housing 102 and fixedly attached thereto. Components mounted on rigid platform 402 are presumed to be aligned and calibrated to enable reliable generation of holograms within holographic recording material 222, a portion of which is shown in cross section in FIG. 4.

Beam source 104 generates electromagnetic beam 406, a wavelength or wavelengths of which may be controlled by control module 116. Beam 406 is redirected by one or more mirrors or other reflective elements 408(1)-408(3) to beam splitter 106, which splits beam 406 into object beam 412 and reference beam 464. Beam splitter 106 may take form in a polarizing beam splitter. Source 104, reflective elements 408(1)-408(3), and beam splitter 106 are fixedly mounted to rigid platform 402. In one embodiment, beam splitter 410 can be controlled by control module 116 to adjust the path lengths of object beam 412 and reference beam 464. For example, beam splitter 410 can include a combination of minors and prisms that are mounted on a small adjustable stage. This stage may be adjusted, e.g., by using a translation motor, for automatic path length adjustment (e.g., as determined and controlled by control module 416). Once adjusted, the stage can be locked in place to prevent further movement thereof or components mounted thereto. In one implementation, beam splitter 410 includes a wave-plate for varying a ratio of transmitted and reflected beams.

Object beam module 110 may include various optical elements, including a refraction element 414, a modulator 418, optical elements (e.g., lenses) 422 and 440, a beam reflecting element 444, and a lens system 448. Each of these optical elements can be fixedly mounted on platform 402. It is noted object beam module 110 can include different, additional, and/or fewer elements, as desired. One or more features of the object beam module 110 can be controlled by control module 116.

Object beam 412 can be propagated through refraction element 414 to generate a refracted object beam 416. Refraction element 414 can be implemented in various ways, such as by using a Galilean telescope. In one implementation, object beam 412 is spread by a Galilean telescope so that the object beam is spread evenly across an imaging device used in modulator 418.

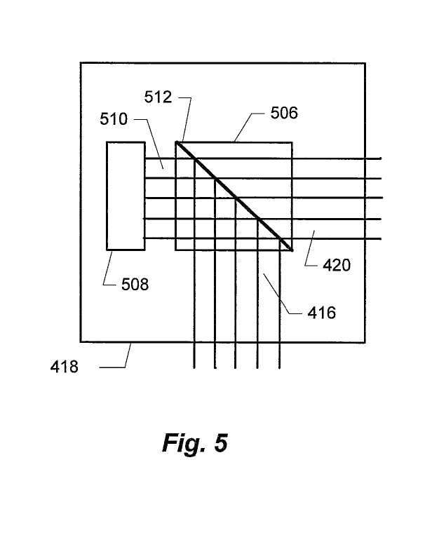

Refracted object beam 416 is conditioned by modulator 418 to generate modulated object beam 420. Modulator 418 is configured to modulate refracted object beam 416 in accordance with data received from image data module 118 (see FIG.1). In one embodiment, the modulated object beam 420 can be phase modulated. By using phase modulation, imperfections present in modulator 418 are not imaged in the resulting hologram. Modulator 418 can be implemented in various ways, such as described with reference to FIG. 5.

Modulated object beam 420 can be propagated to optical element 444 via optical elements 422 and 440. Optical element 444 may take form in a band limited diffuser (BLD) and can be configured to propagate modulated object beam 420 to lens system 448. A Fourier aperture 426 may propagate modulated object beam 420 between optical elements 422 and 440. In one implementation, optical elements 422 and 440 are a part of a telecentric and afocal lens system for magnifying and relaying the modulated object beam. It is noted that different optical elements can be used instead of and/or in addition to optical elements 422 and 440.

Lens system 448 converges the modulated object beam. Lens system 448 can implement a Fourier Transform Lens (FTL). Lens system 448 can also implement a band limited diffuser (BLD). The FTL can rely on Fourier aperture 426 to block a diffraction pattern that could be created by a pixel structure of a display used in modulator 418 to condition object beam 416. The FTL can create a converging spherical wavefront, which is a conjugate of a desired hogel image. In one implementation, the FTL has an angular field of 90 degrees or more.

Lens system 448 is configured to direct and/or condition the modulated object beam to interfere with the reference beam in recording material 222. The interference of the modulated object beam with the reference beam creates hogels. Furthermore, the focus of a Fourier transform lens within lens system 448 can be calibrated to maintain the focus at a specific distance from the surface of recording material 222.

Reference beam module 108 may include various optical elements, including 4f relays (elements 466, 468, and 470) and two steering mirrors 472 and 474. It is noted that reference beam module 108 can include different, additional, and/or fewer optical elements, as desired. Various features of the reference beam module can be controlled by control module 116.

In one implementation, each of 4f relay elements 466, 468, and 470 may take form in one or more lenses that relay reference beam 464 from input to output. Each of 4f relay elements 466, 468, and 470 can be implemented using a respective tube (or a similar element) that houses lenses of that 4f relay element. In other words, each of elements 466, 468, and 470 can operate as a separate 4f relay. In one implementation, reference beam 464 passes through an aperture 465, which is located between beam splitter 106 and first 4f relay element 466. Aperture 465 can limit the shape of reference beam 464. First relay element 466 can have a different focal length when compared to focal lengths of 4f relay elements 468 and 470.

Reference beam 464 may be out-of-plane when propagated through first 4f relay element 466. In one implementation, steering mirror 472 can reflect reference beam 464 in the x-axis, and second steering mirror 474 can reflect reference beam 464 in the y-axis. These two steering mirrors can be arranged orthogonally to create an XY scanner effect. In one implementation, each of these two steering minors can be adjusted by a motor, such as a servo motor (not shown), which is controlled by control module 116. In another embodiment, the steering mirrors could be manually adjusted, and the settings would be fixed. Once adjusted, however, steering mirrors 472 and 474 are locked in place to prevent further movement.

Second steering minor 474 reflects reference beam 464 to third 4f relay element 470. The use of the 4f relay system along with the two steering mirrors allows reference beam 464 to be directed to any portion of a lens at the input of third 4f relay element 470. Third 4f relay element 470 propagates reference beam 464 as a directed reference beam to interfere with the modulated object beam with an angle measured with respect to recording material 222.

In another embodiment, the two steering minors (elements 472 and 474, also referred to as scanners or galvanometers) can be mounted on rigid platform 402 with the same orientation. In this embodiment, a dove prism, or other compound prism, can be used to rotate the scan orientation. The prism could be integrated into the 4f relay system between the scanners. The last 4f element 470 relays a nodal point scan to the surface of holographic recording material 222. The aperture is imaged to the surface of the holographic recording material 222. This steering system may reduce distortions in the final holographic image by pointing the reference beam at the ultimate position of the reconstruction beam source. Example implementations and use of steering systems are described by the '088 and '496 patents.

Steering mirrors 472 and 474 can fold and redirect the reference beam at the x-axis and the y-axis, allowing control module 116 to direct the reference beam from second steering minor 474 to a desired position on a lens of 4f relay element 470. By using nodal point scanning, the angle of incidence and the location of reference beam on the lens of 4f relay element 470 can be controlled. As a result, the angle at which directed reference beam 484 interferes with the modulated object beam at recording material 222 can be adjusted by control module 116. In one implementation, steering minors 472 and 474 direct the reference beam (with a specified angle of incidence) to interfere with the modulated object beam at a specified position in holographic recording material 222. The angle of incidence characterizes an angle of the reference beam with respect to a normal of the hogel (where the interference is occurring). Control module 116 can adjust the angle of incidence when creating multiple hogels, with each angle of incidence being independent of each other.

Some or all of the components in reference beam module and the object beam module can be fixedly mounted on platform 402, which in turn is structurally integrated with housing 102 and movable translation portion 206. Because housing 102 and movable translation portion 206 are limited to movement along the first line during hogel generation, movement of components of the reference and object beam modules are likewise limited. By avoiding separate movable platforms for the reference and object beam modules, synchronization, alignment and calibration issues that can arise through use of separate platforms are greatly reduced. In other words alignment and synchronization requirements for the reference and modulated object beams are greatly reduced using a single platform 402 so that the two beams stay in alignment during hogel generation.

As noted at the beginning of this Detailed Description, a recording material system can be fixedly attached to the base. The recording material system can secure holographic recording material 222 in place as hogels are recorded therein. The recording material system may contain a mechanism that advances the holographic recording material 222 along the second line after a row or line of hogels is created. With continuing reference to FIG. 4, the recording material system may include a holographic recording material supply reel 458 located within a cavity of housing 102. In this embodiment, holographic recording material 222 takes form in a flexible film. A material holder 446 is fixedly attached to the base and provides a surface 450 that supports recording material 222 as hogels are recorded. In one embodiment, support surface 450 is in a plane that is parallel to planes in which respective components (e.g., lens system 448) on platform 402 move during the recording process. FIG. 4 shows surface 451 of stationary translation module 204 is in the same plane as surface 450 of holder 446. In one embodiment holder 446 and module 204 may be a single, integrated structure whose surfaces 451 and 450 are simultaneously machined to be in the same plane. With surfaces 450 and 451 in the same plane, components within the hologram recorder should be indexed to the same surface on which material 222 is supported. FIG. 4 shows module 204 and holder 446 in cross section and formed as a single, integrated structure with openings 455 and 457 through which the recording material 222 and beam 484 can respectively pass.

Housing 102 and platform 402 are C-shaped, which enables the modulated object beam and the reference beam to illuminate oppositely facing surfaces of recording material 222 as shown in FIG. 4. This feature permits the consolidation of the optical system (i.e., the electromagnetic source(s), the beam splitters, and the object beam and the reference beam modules within one mechanical structure, i.e., the holographic recorder. Due to the precision needed for recording hogels, the reference and the modulated object beams should be precisely aligned and calibrated. Such alignment and calibration of the reference and modulated object beams (e.g., as performed by calibration module 120) can be simplified when a C-shaped configuration is used. This simplification is achieved, for example, because components of both the object beam module and the reference beam module are fixedly attached to the same integrated structure, i.e., platform 402, which in turn moves along the first line relative to the base and recording material. In one embodiment, the base can be monolithic, i.e., implemented using a substantially single piece of material, such as stone, metal, or a composite material (e.g., fiberglass). It is noted that the term “substantially single piece” is meant to encompass implementations where two or more pieces are fastened together (e.g., glued, welded, and/or otherwise mechanically attached together).

In one embodiment, the hologram recorder can cure holograms by selectively illuminating recording material 222 with ultraviolet (UV) light. In some implementations, recording material 222 can be cured after being exposed with the modulated object beam and the reference beam. With continuing reference to FIG. 4, UV elements 486A and/or 486B can be fixedly mounted on platform 402 near elements 448 and 470, respectively. Depending on implementation, UV elements 486A/486B apply UV light to one or both surfaces of the recording material 222. In one embodiment, a different wavelength of light can be used instead of UV light. The wavelength can be determined based on type of the recording material 222.

By mounting the UV sources on platform 102 near elements 448 and 470, UV curing is brought closer to the point at which beams interfere within recording material 222, which can reduce the time needed to generate holograms. In one embodiment, the UV light is applied to the recording material 222 soon after hogels are generated, and before the recording material 222 is advanced along the second line. In another embodiment, the UV light is applied to one or more rows of hogels at a time. In one implementation, a size of the area on recording material 222 that is illuminated by the UV light can be several hogels in width.

With continuing reference to FIG. 4, FIG. 5 conceptually illustrates several components of modulator 418 according to one embodiment. Modulator 418 includes an optical unit 506 that includes an optical element 512. Optical unit 506 receives object beam 416, which is then redirected using optical element 512 to lens 422 (see FIG. 4). Optical unit 506 also receives image light 510 from image generator 508. In one implementation, image generator 508 is implemented using a projector unit, such as a liquid crystal on silicon (LCOS), a liquid crystal display (LCD), a digital light processing (DLP) element, and/or another projecting unit. Optical unit 506 allows object beam 416 to be modulated with image light 510. The resulting modulated object beam image can be used to generate holograms. Image generator 508 and other elements of modulator 418 can be controlled by control module 116. In one embodiment, data for generating the image light is received from an image data module, such as image data module 118. In one embodiment, optical unit 506 can be implemented using transmissive or reflective or transflective technology.

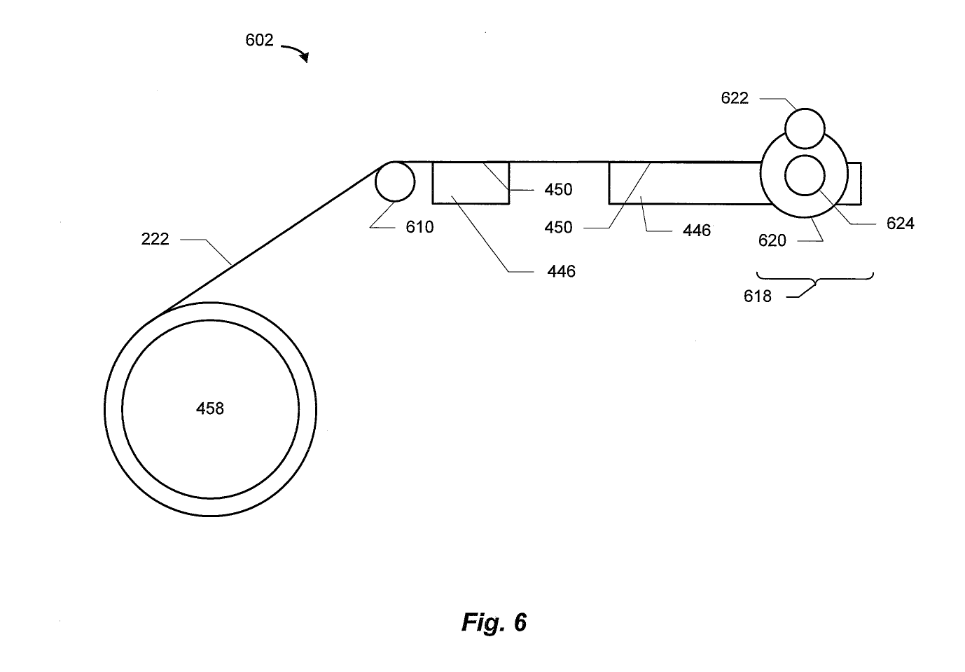

With continuing reference to FIGS. 1 and 4, FIG. 6 is a diagram conceptually illustrating several components of the recording material system according to one embodiment. Recording material system 602 includes supply reel 458 containing recording material 222. A guide device 610, such as an idler roller, directs movement of recording material 222 to support surface 450. Hogels are recorded in the gap within support surface 450. Once a row of hogels is created (and optionally UV curing is completed as well), recording material 222 is advanced through a material advancing module 618 onto a take-up reel 620. Material advancing module 618 may use nip rollers to engage and advance recording material 222.

In one embodiment, an actuator driven clamp (not shown) can grab a leader or leading edge of recording material 222 after a cartridge with a fresh supply reel of recording material is inserted into the holographic recording material system. The cartridge can mate with the holographic recording material system to form a light tight unit. The recording material can engage with the recording material supply reel using a passive capture mechanism. The recording material can then be unwound from the supply reel of the cartridge. The unwinding of the recording material can be implemented using a nip roller. The passive capture mechanism can release the recording material when pulled out by the nip roller so that substantially all recording material is used. If the supply reel becomes empty or if a supply reel change is desired for any reason, the supply cartridge can be changed.

In the alternative, a sheet feeding mechanism can be used instead when the recording material is provided in separated sheets as opposed to being provided as a continuous film on supply reel 458. The sheet feeding mechanism can feed a sheet (of the recording material) into the hologram recorder without a take-up system. The hologram recorder then generates the hologram, e.g., line-by-line as described above, and the sheet of the recording material is fed out accordingly.

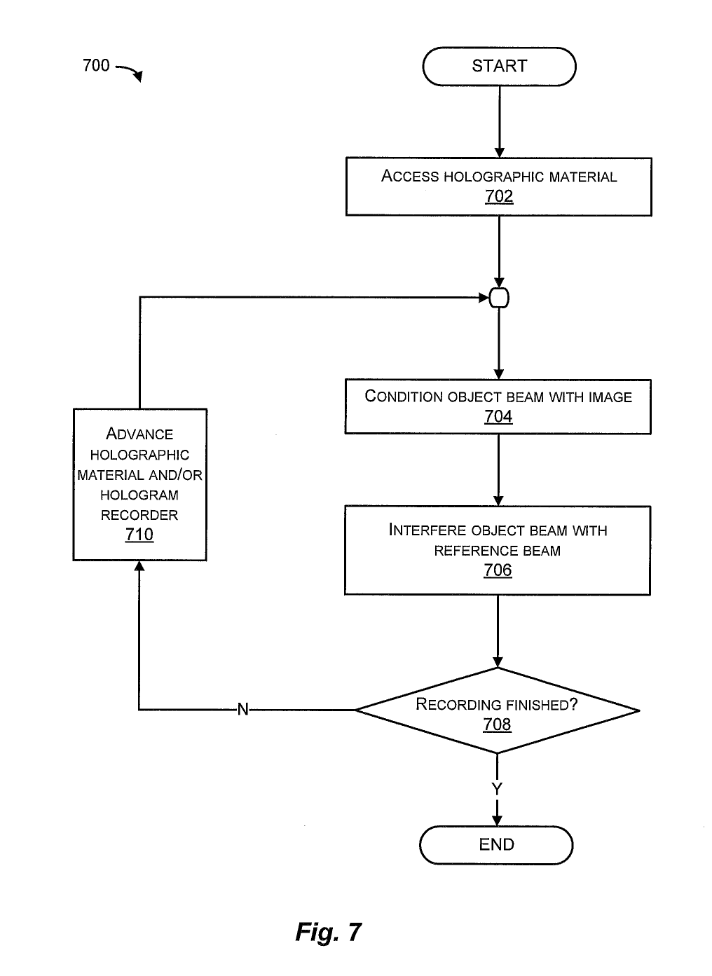

FIG. 7 illustrates a flowchart of a method 700 illustrating the operation of a hologram generating device, according to one embodiment. As will be appreciated in light of the present disclosure, this method may be modified in order to derive alternative embodiments. Also, the steps in this embodiment are shown in sequential order. However, certain steps may occur in a different order than shown, certain steps may be performed concurrently, certain steps may be combined with other steps, and certain steps may be absent in another embodiment. Method 700 is described with reference to variations of the elements described in FIGS. 1-6.

In element 702, holographic material is accessed, according to one embodiment. In one implementation, a control module can move the hologram recorder and/or advance the recording material to desired position. In one implementation, the control module can simply access the holographic material at an initial location of the hologram being generated.

In element 704, the object beam is modulated with image data, according to one embodiment. In one implementation, the control module modulates the object beam to reflect a certain view of image data.

In element 706, the modulated object beam is interfered with the reference beam to generate a hogel in the recording material. In one embodiment, the modulated object beam reflects a certain view of an element of the image, whereas the reference beam indicates a viewing angle of the hogel. It is noted that in element 706, the reference beam can be used to record multiple angles, such as by adjusting the steering mirrors in the reference beam path. In one implementation, a single hogel has multiple reference angles, and is created by performing an interference using multiple angles of the reference beam.

In element 708, the control module determines whether the recording of the hologram is finished. If recording of the hologram is complete, method 700 ends. If the recording is not finished, the holographic material and/or the hologram recorder are advanced. The control module determines which of the holographic material and/or the hologram recorder to advance based on the position of the hologram recorder with regard to the holographic recording material. The control model may also determine whether additional processing (e.g., UV curing) is needed on the holographic recording material, and/or remaining image data is left. For example, the control module can determine whether to advance the hologram recorder along the first line, or to advance the holographic material along the second line.

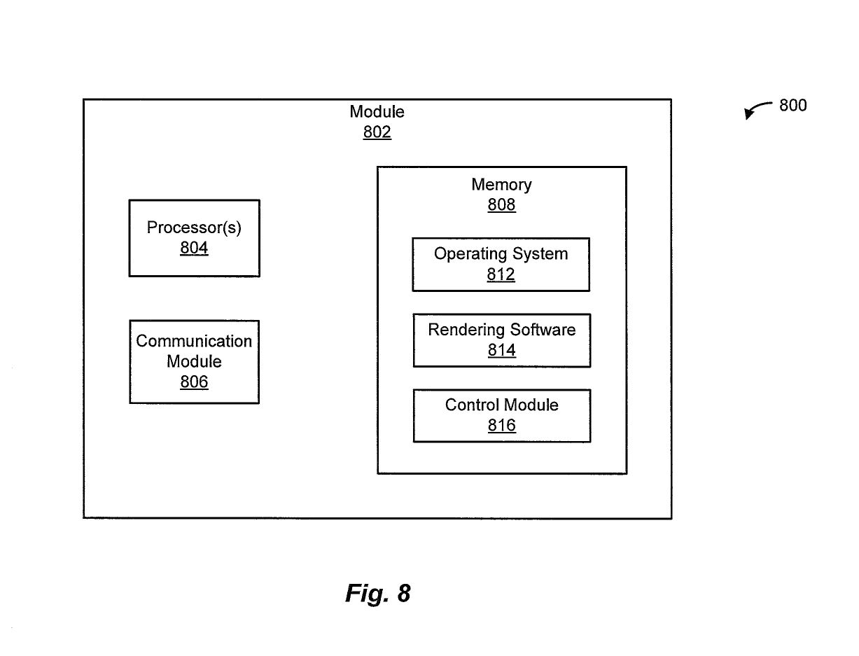

FIG. 8 is a block diagram 800 of a module 802 that can implement control module 116, calibration module 120, and/or image data module 118 of FIG. 1, according to one or more embodiments. Module 802 includes one or more processor(s) 804, a communication subsystem 806, and memory 808. Memory 808 can include one or more of operating system 812, rendering software 814, and control module 816. Processor(s) 804 can execute one or more of operating system 812, rendering software 814, and/or control module 816. Rendering software 814 can implement techniques to process/generate image data. Communication subsystem 806 can facilitate communication with other components. It is noted that in some embodiments, one or more of elements of module 802 may not be used. In some embodiments, one or more of elements of module 802 may be combined, as desired.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. An apparatus, comprising:
a base
a rigid platform, wherein the rigid platform is movably coupled to the base;
a source for emitting an electromagnetic beam;
a beam splitter for splitting the electromagnetic beam into an object beam and a reference beam;
a reference beam component for receiving the reference beam;
an object beam component for receiving the object beam;
wherein the source, the beam splitter, the reference beam component, and the object beam component are fixedly mounted to the rigid platform.

2. The apparatus of claim 1 further comprising a holographic recording material in which a plurality of hogels can be recorded.

3. The apparatus of claim 2 further comprising a surface for supporting the holographic recording material, wherein the surface is contained in a plane that is substantially parallel to a first plane in which the source beam moves, and a second plane in which the beam splitter moves.

4. The apparatus of claim 3 further comprising:
a second object beam component fixedly mounted to the rigid platform and configured to modulate the object beam with image data to generate a modulated image beam;
a second reference beam component for directing the reference beam to interfere with the modulated object beam within the holographic recording material.

5. The apparatus of claim 4 wherein the rigid platform is configured to move along a first line, and the holographic recording material is configured to move along a second line that is substantially orthogonal to the first line.

6. The apparatus of claim 5 wherein the modulated object beam and the reference beam are configured to illuminate oppositely facing surfaces, respectively, of the holographic recording material.

7. The apparatus of claim 6 further comprising:
a housing, wherein the rigid platform is fixedly attached to the housing;
wherein the housing comprises an opening through which the holographic recording material extends as the oppositely facing surfaces of the holographic recording material are illuminated with the modulated object beam and the reference beam, respectively.

8. The apparatus of claim 7 further comprising a means for advancing the holographic recording material through the opening.

9. A method comprising:
a source generating an electromagnetic beam;
a beam splitter splitting the electromagnetic beam into an object beam and a reference beam;
a reference beam component receiving the reference beam;
an object beam component receiving the object beam;
recording a hogel in a holographic recording material in response to the beam splitter splitting the electromagnetic beam;
moving the source, the beam splitter, the reference beam component and the object beam component along respective lines that are parallel to a first line after the recording of the hogel in the holographic recording material.

10. The method of claim 9 further comprising an act of, after the moving, moving the holographic recording material along a second line that is orthogonal to the first line.

11. The method of claim 9 wherein the first and second lines are contained in first and second planes, respectively, that are parallel to each other.

12. The method of claim 11 further comprising an act of recording another hogel in the holographic recording material after the moving of the source, the beam splitter, the reference beam component and the object beam component.

13. The method of claim 12 wherein the respective lines are contained in respective planes that are parallel to each other.

14. An apparatus comprising:
a source generating an electromagnetic beam;
a beam splitter splitting the electromagnetic beam into an object beam and a reference beam;
a reference beam component receiving the reference beam;
an object beam component receiving the object beam;
a material for recording a hogel;
means for moving the source, the beam splitter, the reference beam component and the object beam component along respective lines that are parallel to a first line.

15. The apparatus of claim 14 further comprising a means for moving the material along a second line that is orthogonal to the first line.

16. The apparatus of claim 15 wherein the first and second lines are contained in first and second planes, respectively, which are parallel to each other.

17. The apparatus of claim 16 wherein the respective lines are contained in respective planes that are parallel to each other and the second plane.

18. The apparatus of claim 14 wherein the means for moving the source, the beam splitter, the reference beam component and the object beam component comprises a rigid structure upon which the source, the beam splitter, the reference beam component and the object beam component are rigidly mounted.

19. The apparatus of claim 18 further comprising:
a second object beam component fixedly mounted to the rigid structure and configured to modulate the object beam with image data to generate a modulated image beam;
a second reference beam component for directing the reference beam to interfere with the modulated object beam within the material.

20. The apparatus of claim 1 further comprising:
a housing that houses the source, the beam splitter, the reference beam component, the object beam component and the rigid platform;
a flat plane surface;
a device fixedly coupled to the housing and movably coupled to the flat plane surface;
wherein the flat plane surface is configured to support a holographic recording material in which a plurality of hogels can be recorded;
and wherein the device enables translation of the housing in a plane that is parallel to the flat plane surface.
